(19) United States
(12) Patent Application Publication
(10) Pub. No.: US 2003/0195831 A1
(43) Pub. Date: Oct. 16, 2003

(54) Portfolio generation using resampled efficient frontiers and interval-associated groups

(75) Inventor: Barry Feldman, Chicago, IL (US)

Correspondence Address: Jefferson Perkins, PIPER RUDNICK, P.O. Box 64807, Chicago, IL, 60440-0807, US

(73) Assignee: IBBOTSON ASSOCIATES, INC.

(21) Appl. No.: 10/121,071

(22) Filed: Apr. 12, 2002

(51) Int. Cl. G06F 17/60

(52) U.S. Cl. 705/36

(57) ABSTRACT

Historical data on the returns of a set of risky assets are resampled in each of a plurality of simulations to create sets of resampled risky asset return data. Simulated efficient investment portfolios of assets are assembled on a sheaf of efficient frontiers, one for each simulation. A set of intervals of a statistical input parameter (such as standard deviation) is defined. Each simulated efficient investment portfolios is assigned to an interval. A summary statistical procedure operates on all of the simulated investment portfolios associated with each interval, thereby deriving a resampled efficient investment portfolio. The resampled efficient investment portfolios reside on a resampled efficient frontier and are presented to an investor as a guide to making investments or are used as an input for other automated procedures.

### TECHNICAL FIELD OF THE INVENTION

The present invention pertains to the selection of investments, and more particularly to the optimal allocation of investment among a set of risky assets subject to measurement error in the statistical properties of the expected returns of those assets.

### BACKGROUND OF THE INVENTION

One formulation of the task of an investment manager is to seek a maximum return for a given level of risk. This is done by investing a sum of money among a number of risky assets. H. Markowitz, Portfolio Selection; Efficient Diversification of Investments (Wiley, 1959) developed a solution for this problem wherein risk is measured in terms of the variance of a risky asset's returns and wherein only a single time period is considered. The return of an asset over a time period is the percentage change in its price plus the value, in percentage terms relative to its initial price, of any dividends or other distributions. Markowitz showed how to construct an optimal portfolio for a specified level of risk given only the expected returns and variances of the returns on each risky asset and the correlations between pairs of risky asset returns. These are the statistical parameters of the mean-variance optimization problem. The set of all mean-variance optimal portfolios describes an efficient frontier.

FIG. 1 illustrates a mean-variance chart and an efficient frontier. The horizontal axis of the chart represents the standard deviation of the return of a risky asset or portfolio of risky assets. The vertical axis of the chart represents the expected return of a risky asset or portfolio of risky assets. A portfolio's location on the chart is determined by its expected return and standard deviation. Investors will prefer portfolios with higher expected returns, given the same expected standard deviation in that return. Thus, portfolio A is preferred to portfolio B, directly below it. Similarly, investors will prefer portfolios with less risk given the same expected return. Thus, portfolio A will be preferred to portfolio C, directly to its right. The mean-variance efficient frontier 100 represents the set of portfolios having the property that no portfolio has a higher expected return with the same, or lower, expected standard deviation. Equivalently, portfolios on the efficient frontier 100 have the property that no other portfolio has the same or higher return at a lower level of expected standard deviation. Portfolio D is an example of a portfolio on the mean variance or efficient frontier 100.

One problem with mean-variance optimization is that the true values of the statistical parameters (e.g. expected return and standard deviation) of an asset are not, in practice, actually known. They must be predicted. Under reasonable assumptions, they may be estimated on the basis of the historical performance of the assets. However, the estimation procedure necessarily introduces measurement error. The nature and extent of measurement error has been the subject of a number of articles, including, J. D. Jobson and B. Korkie, “Estimation for Markowitz Efficient Portfolios,” Journal of the American Statistical Association, Vol. 75, September 1980, 544-554, and R. Michaud, “The Markowitz Optimization Enigma: Is ‘Optimized’ Optimal?” Financial Analysts Journal, January/February 1989.

Resampling is a process whereby a large number of sets of data statistically similar to an original set of data are randomly generated and statistical estimates are based on the resampled sets of data. A number of researchers have developed resampling-based methods to generate efficient frontiers. These methods may reduce the influence of errors in the estimation of optimization inputs. They may also result in generally more diversified portfolios.

P. Jorion, “Portfolio Optimization in Practice,” Financial Analysts Journal, February 1992, pp. 68-74, applies resampling to the analysis of a single portfolio on an efficient frontier, determining a statistical equivalence region.

D. DiBartolomeo, “Portfolio Optimization: The Robust Solution,” Prudential Securities Quantitative Conference, 1993, (http://www.northinfo.com/papers/pdf/19931221_optimization_robust.pdf) describes a method wherein portfolios generated by the resampling process are grouped by a common risk tolerance coefficient. Resampled portfolios are grouped together by associating resampled portfolios to efficient frontier portfolios by their expected return or standard deviation based on resampled statistical inputs. The portfolios so grouped are used to construct a statistical confidence region for a corresponding portfolio on the efficient frontier. The average of the grouped portfolios is also calculated. Such an average constitutes a point on a resampled efficient frontier.

Y. Liang, F. C. Myer, and J. R. Webb, “The Bootstrap Efficient Frontier for Mixed-Asset Portfolios,” Real Estate Economics, September 1996, pp. 247-256, group resampled portfolios by their resampled expected return, average them to construct resampled portfolios, and compute confidence intervals. Results are presented for 9 levels of expected return.

R. Michaud, Efficient Asset Allocation, Harvard University Press, 1998 and U.S. Pat. No. 6,003,018, “Portfolio Optimization by Means of Resampled Efficient Frontiers,” claims a generalized many-to-one procedure for grouping resampled portfolios. In one embodiment a set of portfolios on the mean-variance efficient frontier is identified and the portfolios are ordered by rank. This rank may be, for example, in order of increasing variance. A set of portfolios on each resampled efficient frontier is also identified and the portfolios are also ranked in the same manner. All resampled portfolios having the same rank are then grouped together to form an “index-associated” set. An asset's relative weight in a resampled efficient portfolio is then defined as the average of its weights over all index-associated portfolios. Michaud also describes an alternate embodiment whereby portfolios are grouped by a “lambda value” related to an investor's risk/return preference.

The present invention differs from Michaud's in several obvious respects. There is no need to construct an indexed set of portfolios on the efficient frontier. The current resampling method may be applied to other optimization procedures and is not limited to mean-variance optimization. Embodiments of the present invention do not require calculation of an unresampled efficient frontier. It is not necessary to execute a complete resampling process. Other differences will become apparent in the detailed description of the invention.

U. S. Pat. No. 6,275,814 issued to Giansante includes a type of resampling process (Monte Carlo simulation) for the selection of portfolios. One embodiment of the Giansante disclosure uses an asset pricing model that uses alpha (a measure of how much the return of an asset exceeds that of a benchmark having the same risk) and beta (a measure correlating movement of the return of the asset with, or against, the market). Another embodiment uses a screening procedure to select assets in advance for suitability in inclusion in the optimization process The present invention does not require the use of an asset pricing model or a screening procedure.

FIG. 2 illustrates the relationship between an efficient frontier and a resampled efficient frontier. The expected return of a portfolio on the resampled efficient frontier must always be lower, or at most, equal to the expected return of a portfolio from the efficient frontier with an equal expected standard deviation. Portfolios from the resampled efficient frontier may still be preferred because their actually realized risk and return characteristics may turn out to be superior to portfolios from the efficient frontier. Those familiar with the art understand this as exhibiting better expected out-of-sample performance.

It should also be appreciated that measures other than standard deviation can be used to quantify investment risk. These include semivariance, scale, interquartile range, and a gini coefficient. Standard deviation is most commonly used, partly because of computational simplicity and partly due to ease of understanding. Procedures for identifying efficient frontiers for other risk measures are known to those familiar with the art. The method described here for generating a resampled efficient frontier may be used with these procedures as well. Examples of the use of alternative risk measures in a portfolio optimization process include S. Haim and S. Yitzhaki, “Mean-Gini, Portfolio Theory and the Pricing of Risky Assets,” Journal of Finance, Vol. 39, pp. 1449-1468, and V. S. Bawa, E. J. Elton, M. J. Gruber, “Simple Rules for Optimal Portfolio Selection in Stable Paretian Markets,” Journal of Finance, Vol. 34, 1979, pp. 1041-1047.

### SUMMARY OF THE INVENTION

The present invention provides methods, systems and programmed computer products for formulating investment portfolios on a resampled efficient frontier using statistical input parameters for a set of risky assets. Each of the risky assets is characterized by at least two, and preferably more, statistical input parameters, such as mean return, standard deviation in return, and a correlation to each other risky asset.

In a first step according to the method of the invention, a resampling procedure is performed on this data set of risky assets for each of a plurality of simulations, to derive resampled data sets of simulated risky asset returns. Next, and for each of these simulations, an efficient frontier of portfolios of the risky assets is calculated. Separately, a performance measure for portfolios (such as standard deviation) is selected and a plurality of intervals of the performance measure are defined. Preferably each of these intervals describes a continuous subset of the total range of the performance measure. The portfolios on the simulated efficient frontiers are assigned to at least one of these intervals according to the value of the portfolio performance measure for that portfolio. Next, for each interval, summary statistics are generated from all of the portfolios that have been assigned to the interval, in order to generate a portfolio for that interval on a resampled efficient frontier. The process yields a set of portfolios along a resampled efficient frontier, which then may be presented to an investor or an investment manager as a guide to making investments. Portfolios generated by this process may also be used as an input to automated methods for the management of portfolios.

In the following detailed description, for the purposes of explanation numerous specific details are set forth in order to provide a thorough understanding of the present invention. However, one skilled in the art will readily appreciate that the present invention may be practiced without some of these specific details. In other instances, well-known structures and devices are shown in block diagram form.

The present invention includes various steps, which will be described below. The steps of the present invention may be embodied in machine-executable instructions. The instructions can be used to cause a general-purpose or special-purpose processor which is programmed with the instructions to perform the steps of the present invention. Alternatively, the steps of the present invention may be performed by specific hardware components that contain hardwired logic for performing the steps, or by any combination of programmed computer components and custom hardware components.

The present invention may be provided as a computer program product which may include a machine-readable medium having stored thereon instructions which may be used to program a computer (or other processor-driven electronic device) to perform a process according to the present invention. The machine-readable medium may consist of or include magnetic media such as floppy diskettes, magnetic hard drives or tapes; optical media such as CD-ROMs and CD-Rs, whether write-once or write-many; electronic memories such as ROMs, RAMs, EEPROMs, DRAMs and EPROMs, and other types of machine-readable media suitable for storing digitally-encoded instructions. Moreover, the present invention may be downloaded as a computer program product, wherein the program may be transferred from a remote computer (e.g., a server) to a requesting computer (e.g., a client) by way of data signals embodied in a carrier wave or other propagation medium via a communication link, such as a modem, network or wireless connection.

The present invention may be operated in a distributed fashion such that different steps in the process may be executed by different processors. Also, it may be operated in such a manner that the results of the process are delivered to another processor, for example, by way of an internet or an intranet. This, for example, would allow a client to review the results of the process without needing the data and software to actually perform the calculations. The present invention may also be designed to operate on nontraditional computing platforms such as PDAs (“personal digital assistants”) and internet appliances.

### BRIEF DESCRIPTION OF THE DRAWINGS

Further aspects of the invention and their advantages can be ascertained from the detailed description set forth below, when taken in conjunction with the drawings, in which like characters illustrate like parts and in which:

FIG. 1 is a graph illustrating a mean-variance efficient frontier, as is known in the art;

FIG. 2 is a graph illustrating a resampled efficient frontier;

FIG. 3 is a flow chart illustrating the steps in a resampling process according to the invention;

FIG. 4a is a graph illustrating the construction of a resampled efficient frontier;

FIGS. 4b and 4c are graphs of alternative embodiment of the invention;

FIG. 5 is a graph illustrating three different types of efficient frontiers for one set of risky assets;

FIG. 6 is a graph illustrating allocations to a risky asset along three different efficient frontiers created by different processes;

FIG. 7 is a graph illustrating three different types of efficient frontiers for another set of risky assets;

FIG. 8 is a graph illustrating allocations to U.S. Large Capitalization equities along three different efficient frontiers;

FIG. 9 is a graph illustrating allocations to Latin American equities along three different efficient frontiers;

FIG. 10 is a schematic diagram of a system for carrying out the invention;

FIG. 10a is a schematic diagram of an alternative system for carrying out the invention;

FIG. 11 is a diagram illustrating typical internal architecture of a personal computer suitable for carrying out the invention;

FIG. 12 is a schematic flow diagram illustrating the operation of representative software modules in carrying out the invention;

FIG. 13 is an area chart of an unresampled mean variance optimization portfolio composition, by risk level; and

FIG. 14 is a area chart of resampled optimal portfolio composition by risk level, corresponding to FIG. 13.

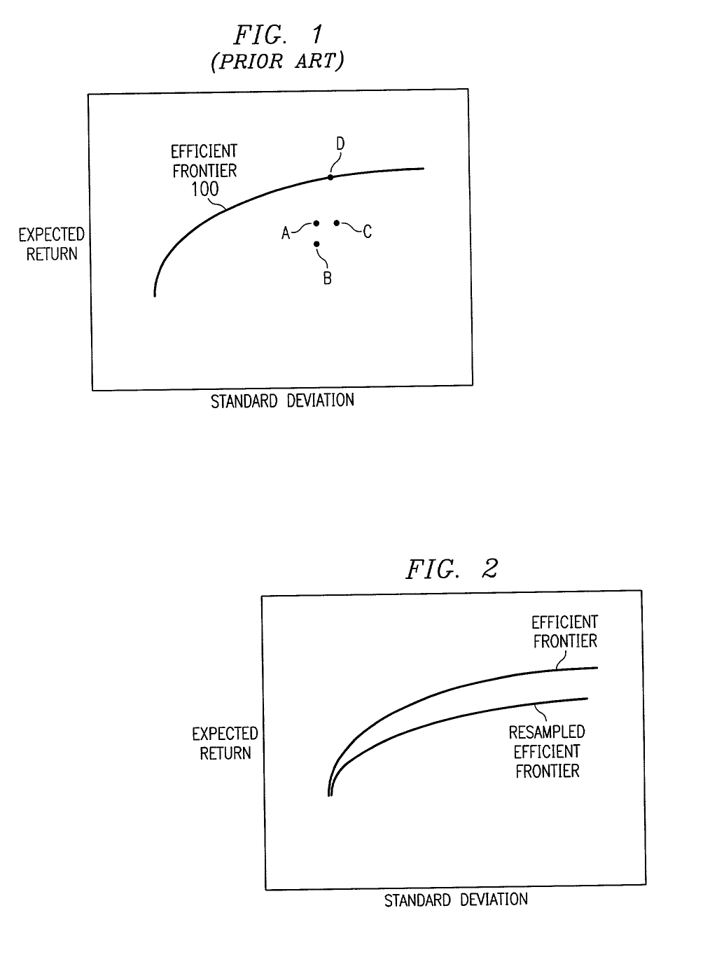

### DETAILED DESCRIPTION OF ILLUSTRATED EMBODIMENTS

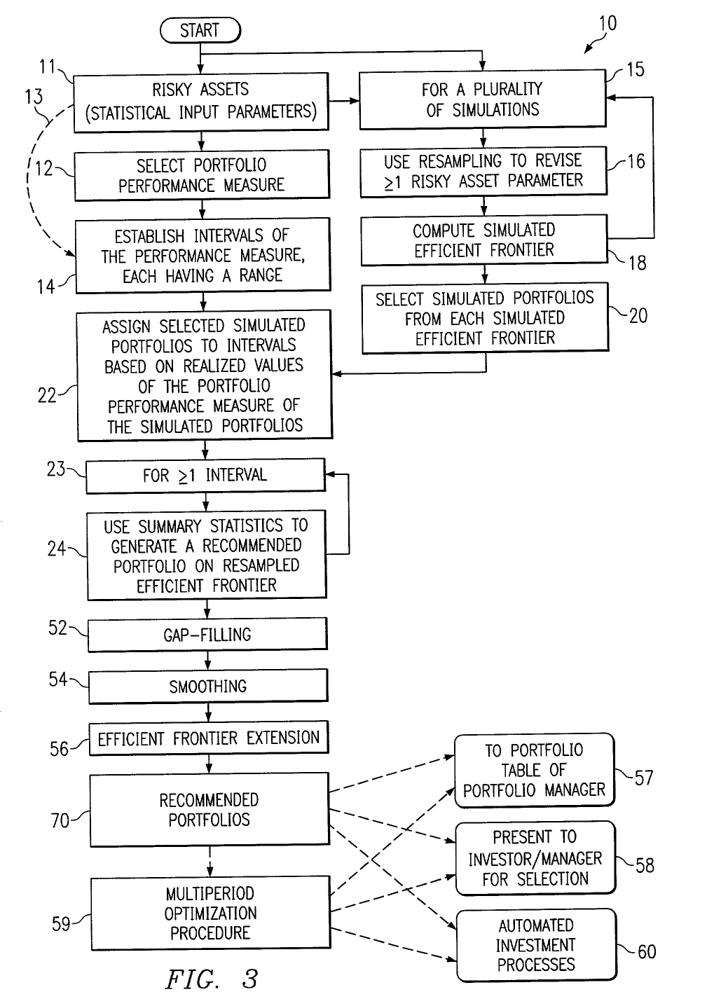

FIG. 3 illustrates a method 10 for determining portfolios on a resampled efficient frontier for a set of risky assets whose returns are characterized by statistical input parameters.

At step 11 a set of risky assets is provided, wherein each risky asset is characterized by a vector of statistical input parameters, such as an expected return, a standard deviation, and a correlation of the assets' returns to the returns of each other risky asset in the set. The statistical input parameters may be based upon historically observed returns, or may be generated by other means. Such other means may include professional judgment, asset pricing models, risk forecasting models, and other methods known to those familiar with the art.

At step 12 a portfolio performance measure is selected. Typical portfolio performance measures include a standard deviation of a portfolio and its expected return. In a preferred embodiment of this invention standard deviation is used as a portfolio performance measure when identifying portfolios on a resampled mean-variance efficient frontier. A portfolio expected return may be used instead, but it will then usually be advisable to discard portfolios with standard deviations higher than the standard deviation of the maximum return risky asset. Other portfolio performance measures may also be selected. For example, when a measure of risk other than standard deviation is used, it may also be selected as a performance measure. Examples of alternative risk measures include semi-standard deviation, interquartile range, the gini coefficient, and custom measures based on skew or kurtosis. It is not necessary that the portfolio performance measure selected is utilized directly in the optimization process.

At step 14 intervals of the portfolio performance measure are established. Generally, the ranges of values for each interval will be subsets of the possible range of values for the performance measure. Preferably, these ranges are established by dividing the entire range of possible values of the performance measure. In a preferred embodiment of this invention a minimum and maximum of the range correspond to the minimum and maximum value of the portfolio performance measure for portfolios on the efficient frontier based on the original statistical inputs (see dashed line 13). The actual efficient frontier need not be constructed in order to determine these extreme points in many cases. In the case of mean-variance optimization when either a standard deviation or an expected return is the portfolio performance measure, the maximum point will be determined by the risky asset with the highest expected return. The minimum point will correspond to the minimum variance efficient portfolio. As is known to those familiar with the art, this portfolio may be computed independently of the rest of the mean-variance efficient frontier.

It may be desirable to identify alternative minimum and maximum values of the portfolio performance measure. In situations where only a portion of the resampled efficient frontier is of interest, the range of the portfolio performance measure is similarly restricted. For example, if it is known that only portfolios returning between 10 and 15 percent are of interest, then expected return may be selected as the portfolio performance measure and the minimum and maximum points may be selected as 10 and 15 percent, respectively.

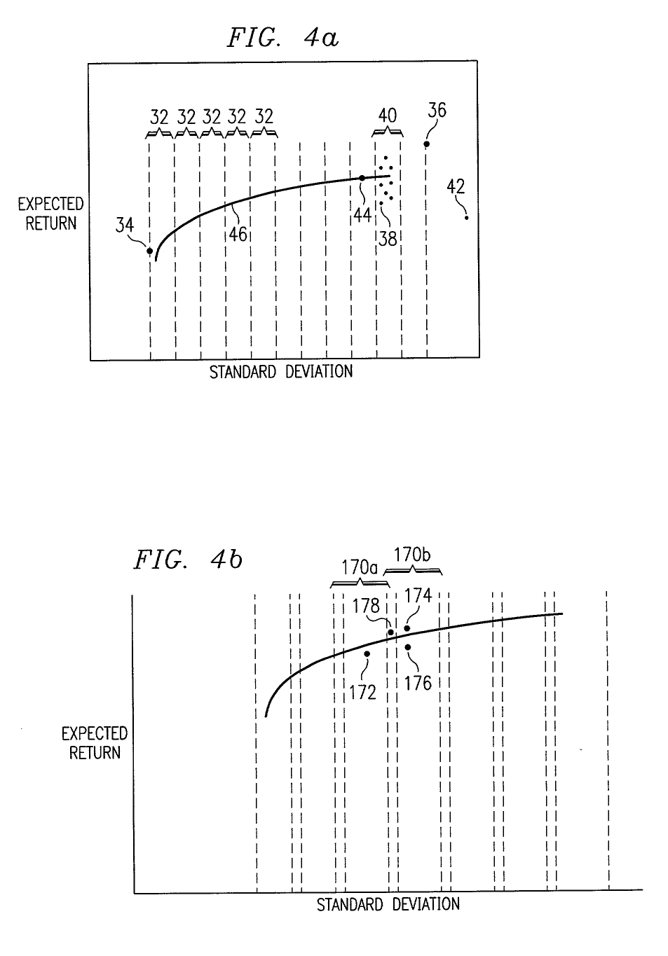

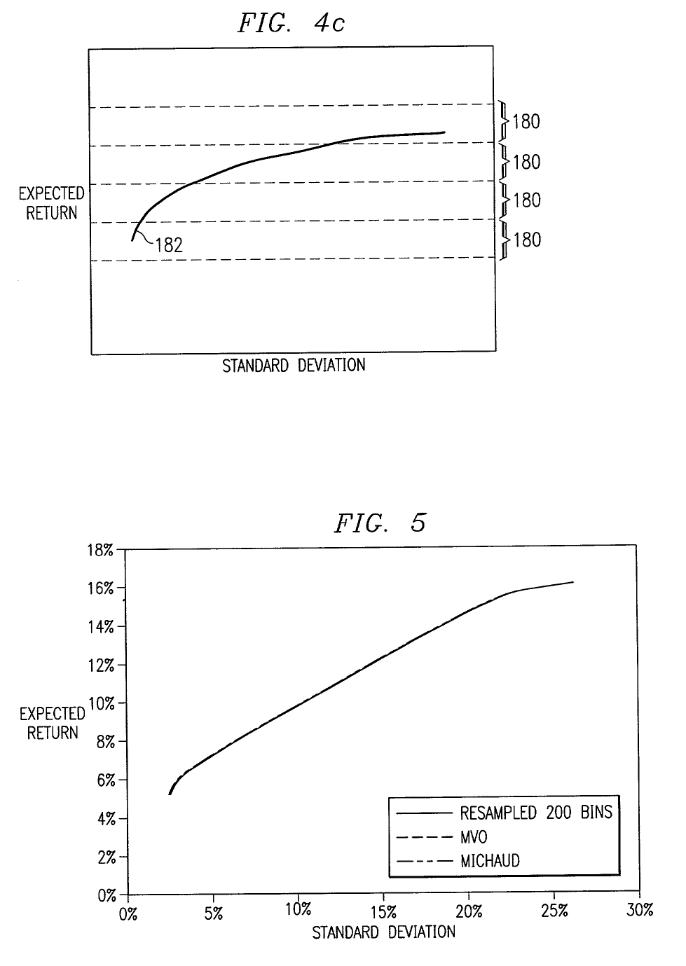

FIG. 4a illustrates a preferred embodiment in which a range of values of standard deviation has been divided into equal non-overlapping intervals 32, between the minimum standard deviation efficient return portfolio 34 and the standard deviation of the maximum return asset 36.

Intervals may also be designed to overlap. This may be useful in obtaining smoother variations in asset allocation weights along the resampled efficient frontier. In this case, some fixed percentage of each interval may be designed to overlap. A portfolio with a realized value of a performance measure that falls into an overlapping region would then be assigned to all groups associated with intervals that contain the realized value of the performance measure.

FIG. 4b illustrates this case. A set of intervals 170 have been set up whose ranges overlap. Thus, the range of interval 170a overlaps the interval 170b. Portfolio 172 will be assigned to the interval 170a, portfolios 174 and 176 will be assigned only to interval 170b, but portfolio 178 will be assigned to both of them.

FIG. 4c illustrates an alternative embodiment in which expected return has been chosen as the portfolio performance measure, and in which the range of expected return has been divided into a number of intervals 180. An efficient frontier 182 of portfolios based on resampled data has been calculated. The portfolios making up the efficient frontier 182 will be assigned to one of the groups 180 in this embodiment of the process.

In other embodiments, the ranges of the intervals may be chosen to be spaced from each other, or of intentionally unequal sizes, or both.

At step 15 a plurality of simulations are computed, with each simulation including steps 16 and 18. At step 16 a resampling procedure is used to revise at least one statistical input parameter of each asset. In a preferred embodiment, a resampling procedure is used to generate a resampled data set consisting of returns of all assets for a chosen number of time periods. Jackknife or bootstrap methods may also be used to generate a resampled data set of asset returns. Selected statistical inputs for the simulation may then be based on the resampled data set. In the preferred embodiment, a random number generator is used to generate random returns drawn from the multivariate statistical distribution 11 characterized by the original statistical inputs. The statistical inputs for the simulation are then based on the randomly generated returns.

Typically, random returns will be generated using a multivariate normal or multivariate lognormal distribution. It, however, may be desirable to use other distributions to account for asymmetry or kurtosis in the empirical distribution. Alternative distributions appropriate for this purpose include the Student-T distribution, the generalized Student-t distribution, the multivariate stable distribution, and distributions based on the Johnson translation system (N. L. Johnson, “Systems of Frequency Curves Generated by Methods of Translation,” Biometrika, vol. 36, pp. 149-176, 1949). When using these distributions, additional or different statistical input parameters will be required, as will be apparent to those familiar with the art.

It is not necessary that all statistical inputs be based on resampled data. As is known to those familiar with the art, it is commonly assumed that expected correlations and standard deviations can be determined with greater accuracy than expected returns. Resampled expected returns can be generated with many fewer computational steps by resampling directly from the expected return distribution for each risky asset. This may be done independently of the correlations between asset class expected returns or from the multivariate distribution of mean returns, which, as is known to those familiar with the art, is easily determined from the multivariate distribution of returns.

At step 18 a simulated efficient frontier for each simulation is computed. This is done by replacing the original statistical inputs with resampled data and applying the appropriate optimization algorithm. In a preferred embodiment of this invention the optimization algorithm is a mean-variance optimization procedure such as constrained quadratic programming. Typically, optimizations will be constrained to require that all risky assets have non-negative allocations. This is equivalent to ruling out short positions. Alternatively, other constraints may be employed or added to the non-negativity constraint.

At step 20, and operating on an accumulated set of simulated efficient frontiers each having a plurality of simulated portfolios, a plurality of simulated portfolios from each simulated efficient frontier is selected. In one preferred embodiment of the invention, the range of the efficient frontier along the risk dimension is divided into a number of equally spaced risk intervals and simulated portfolios at or near the endpoints of the risk intervals are selected. The number of portfolios selected from each simulated efficient frontier need not bear any relation to the number of intervals selected in step 14. Similarly, the spacing of the risk intervals of this step need not be the same as the spacing of intervals determined in step 14a.

At step 22 the simulated, selected portfolios are assigned to interval-associated groups based on a realized value of the portfolio performance measure relative to the portfolio performance ranges of the intervals for that measure. FIG. 4a illustrates that portfolio 38 is assigned to interval 40. In a preferred embodiment of the invention, the standard deviation in return is the performance measure which is used to assign the portfolio to the interval. In the preferred embodiment of the invention realized standard deviations of the simulated portfolios selected in step 20 are then determined based on the original statistical inputs based on unresampled data, and each portfolio is assigned to every interval containing its realized standard deviation. Some portfolios may have a realized value of the portfolio performance measure that does not fall into any predetermined interval of the portfolio performance measure and are effectively discarded from the resampling process. FIG. 4a illustrates such a portfolio 42.

For each of a selected number of the intervals established at step 14, summary statistics for the interval are used at step 24 to generate a recommended portfolio on a resampled efficient frontier. In one preferred embodiment of this invention a mean portfolio is determined for each interval. A mean portfolio is determined by determining the average portfolio weight for each risky asset. Referring now to FIG. 4a, a point 44 on the resampled efficient frontier 46 is generated by determining the mean portfolio of the portfolios grouped into interval 40. Observe that the standard deviation of portfolio 44 falls outside of interval 40. This may sometimes happen and is the result of risk reduction due to greater asset diversification in the resampled portfolio.

The points on the resampled efficient frontier generated in step 24 may be joined to form a resampled efficient frontier 46 (FIG. 4a). The allocations for a particular risky asset may also be collected to generate a graph describing the allocation to that asset as a function of the selected portfolio performance measure. See FIG. 14 for an example.

FIG. 3 shows several optional computational steps which can be taken after a resampled efficient frontier is generated at step 24, but before presenting a range of recommended portfolios to a client.

There may be gaps in the initial resampled efficient frontier. Such gaps may be filled at gap-filling step 52 by adding portfolios that are linear combinations of portfolios already on the resampled efficient frontier. In one preferred embodiment, given a gap between two such portfolios X and Y, an arbitrary number of portfolios may be added by dividing the interval between zero and one into n equally spaced values, α(1) to α(n) and then constructing n portfolios where portfolio P(i) is the result of the vector operation P(i)=α(i)X+(1−α(i))Y.

As shown at step 54, statistical methods may be used to smooth asset allocations as a function of a performance measure. General smoothing techniques may also be employed to smooth asset allocations as a function of a performance measure. Smoothing may be desirable in order to remove irregularities from the resampled efficient frontier or simply to facilitate the functioning of the user interface. Methods commonly used for such purposes include, but are not limited to the Fourier transform, Chebyshev regression, wavelet methods, exponential smoothing, spline fitting, and neural networks. A preferred method for this purpose is polynomial regression using Chebyshev polynomials. In this case, all resampled allocations are regressed on a power series constructed on the selected performance measure of the resampled allocations. When the performance measure is selected as standard deviation, polynomials up to the 25^{th} degree may be efficiently computed, and appear to be sufficient to smooth asset allocations.

It should be appreciated that smoothing may also impose constraints on asset allocations. Smoothed asset allocation weights must still add exactly to unity. It may also be desired to impose other constraints, such as nonnegativity. Also, when allocations are smoothed, the resampled efficient frontier must be based on the smooth allocations.

The resampled efficient frontier generated by method 10 may not cover the entire range of expected return or standard deviation covered by the unresampled efficient frontier, as illustrated in FIG. 7. At step 56 in FIG. 3, the resampled efficient frontier may be extended at an end of its range by adding portfolios constructed by creating linear combinations of one or more portfolios on the resampled efficient frontier with at least one portfolio from the unresampled efficient frontier. When the uncovered range is at the riskier end of the efficient frontier the efficient frontier portfolio consisting entirely of the risky asset with the highest expected return will typically be selected as the efficient frontier portfolio to be used in such a linear combination.

After optimally executing these additional operations 52-56 on the resampled efficient frontier, several portfolios 70, as one per interval, are chosen. These portfolios 70 may be used in different ways in different embodiments. In one embodiment, the resultant portfolios 70 are used to populate a portfolio table of a portfolio manager, as shown in step 57. The portfolio manager may be managing the assets of a single investor, or the assets of an entire plan in which the individual investors have accounts. The plan or portfolio manager may shift an investor from one portfolio to another in an automated fashion as a function of the age and known financial condition of the investor, or the portfolio manager may accept the instructions from the investor as to which portfolio should be chosen. In one embodiment, the portfolio selection/shift is an automatic default which the investor may override.

In one embodiment, the recommended portfolios 70 are presented to the investor or manager for selection, as is shown at step 58. Thus, the efficient frontier portfolio generation method according to the invention can simply produce a range of portfolios for manual selection by an investor, or can be used as an input to further automated investment processes.

In yet another alternative embodiment, the portfolios 70 are used as an input to a multiperiod optimization procedure 59. A multiperiod optimization procedure can incorporate a better model of an investor's situation. It can take into account variances in expected savings rates, changing liabilities, and time series regularities in asset price behavior. One such multiperiod optimization procedure can result in a matrix of portfolios, in which one dimension is risk and another dimension is time. Each “risk indexed” set of portfolios would represent an optimal investment strategy over time. It is also possible to perform multiperiod optimization for pre- and post-retirement periods, and output a set of pre- and post-retirement portfolios. The ranges or sets of portfolios generated by optimization procedure 59 can be input to the portfolio manager 57, or output to a manager or investor for selection, as at step 58, or as an input to automated investment processes 60.

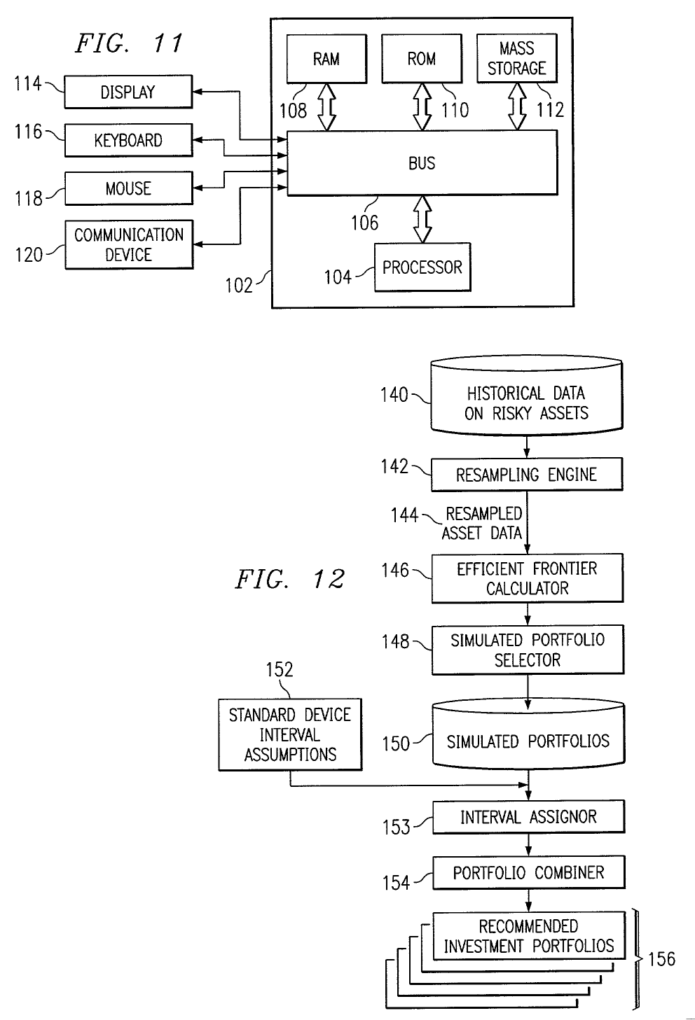

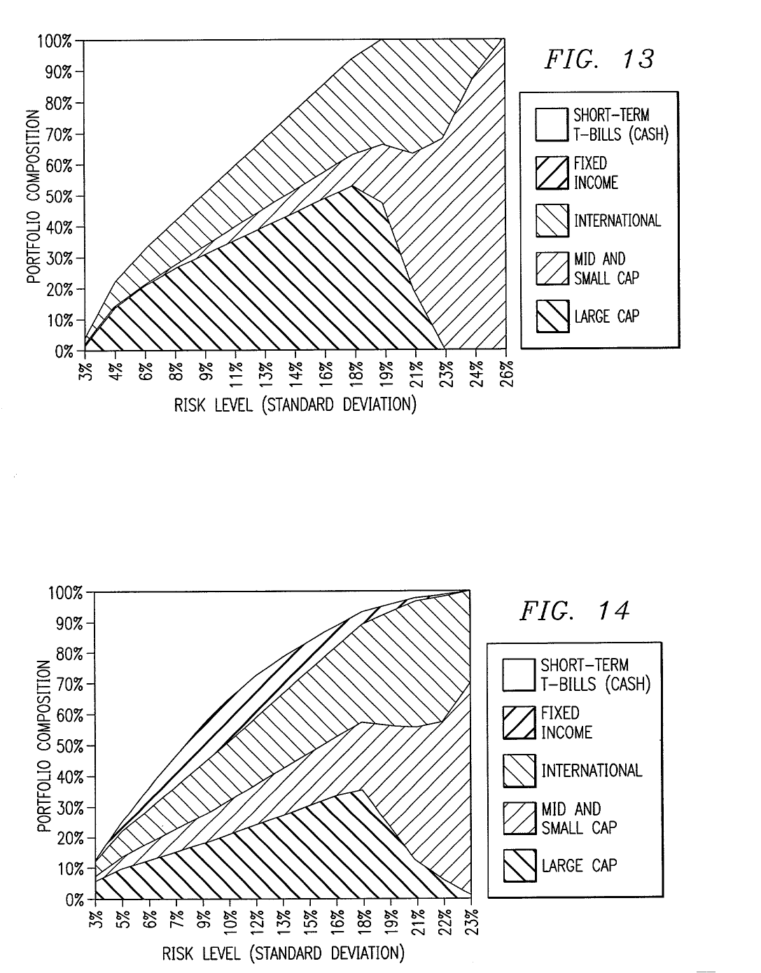

A representative system suitable for carrying out the invention is illustrated in FIG. 10. A portfolio selection system 101 may be assembled around a programmed, general-purpose computer 102 having so-called personal computer (“PC”) architecture; alternatively, other computers may be used, an example being a minicomputer such as those made by Sun Microsystems. Referring to FIG. 11, a highly schematic internal architecture of the computer 102 is shown. In the preferred embodiment, the computer 102's main logic is embodied by a general-purpose, programmable microprocessor 104, which in conventional practice will have an on-board memory cache (not shown) and which may be associated with one or more mathematics or other special-purpose coprocessors (not shown). The processing logic generally represented by processor 104 is connected by a bus structure 106 to the various other components of the computer 102. The schematic representation of bus 106 is shown in FIG. 11 as a simple and unitary structure, but in conventional practice, as is known to those in the art, there usually are several buses and communication pathways 106, operating at different speeds and having different purposes. Further, bus 106 may be segmented and controlled by respective bus controllers, as is also known in the art.

Computer 102 will also have a random access memory unit or units 108 connected to the bus 106. RAM 108 (which may be DRAM, SDRAM or other known types) typically has loaded into it the operating system of the computer 102 and executable instructions for one or more special applications designed to carry out the invention, as will be discussed in conjunction with FIG. 12. Computer 102 also has electronic read-only memory 110 for storing those programs such as the BIOS which are nonvolatile and persist after the computer 102 is shut down. In alternative embodiments of the invention, one or more components of the invention's logic may be hard-wired into the ROM 110 instead of loaded as software instructions into RAM 108. ROM 110 can consist of or comprise electrically programmable read-only memory (EPROM), electrically erasable and programmable read-only memory (EEPROM) of either flash or nonflash varieties, or other sorts of read-only memory such as programmable fuse or antifuse arrays.

In a typical architecture, a computer program suitable for carrying out the invention will be stored on a mass storage device 112, such as an optical disk or magnetic hard drive. The asset data used as a basis for portfolio selection will typically exist as a database on device 112 but could reside on a separate database server and be accessed remotely through a network. Bus 106 connects mass storage device 112 to RAM 108.

The computer 102 is connected to various peripheral devices used to communicate with an operator, such as display 114, keyboard 116 and mouse 118. The computer 102 also uses a communications device 120 such as a modem or a network card to communicate to other computers and equipment.

Returning to FIG. 10, the portfolio selection system or server 102 can be connected to a web server 122, as by means of a hardwired connection 124 (such as an internet connection) or by a wireless method (not shown). The web server acts as a host for a web site, on which is displayed portfolios selectable by an investor, and which is accessible, either remotely (as shown) or nonremotely (not shown) by a client 126.

FIG. 10 illustrates only one of any of a number of possible systems which may use the invention. Instead of traditional desktops 126, for example, the investor may use nontraditional processor-driven devices to make investment selections and provide instructions. Further, the software implementing the system may be distributed over several units, or may be a component of a larger financial investment system. An alternative embodiment to the system shown in FIG. 10 is shown in FIG. 10a. In this embodiment, the portfolio selection system 102 uses an asset database 112 and the method as described herein to generate a series of portfolios, differing from each other in risk and rate of return. This portfolio table is transmitted to an automated plan manager 200, which in this illustrated embodiment manages a retirement plan for a group of participants. The plan manager 200 stores the most recently generated range of portfolios in an investment vehicle table 202. As is shown in this embodiment, the portfolio selection system and the plan manager 200 do not have to be resident on the same computer or even geographically proximate, but can be interconnected via the internet 204 or by other means.

The plan manager 200 manages a plan consisting of a number of accounts maintained for individual investors. These accounts are represented by individual records in a plan database 206. The plan manager 200 executes trades, e.g., of various mutual funds in order to conform the investors' assets either to the wishes of the investors or according to a default automated algorithm where the instructions of the investors have not been determined.

The invention has utility in systems employing nontraditional processor-driven devices, such as personal digital assistants (PDAs) 208, 210 and 212. The PDAs 208-212 each have a wireless connection to a PCI server 214 or other PDA protocol handling device. The PCI server 214 in turn acts as a gateway to the internet 204 and can effect communication via the internet to the plan manager 200. The plan manager transmits data concerning individual investor accounts through the internet 204 and PCI server 214 to selected ones of the PDAs 208-212, so that the individual investors can get a current report on the amount of the financial assets in their accounts and how these assets have been allocated. Instructions to change any of these allocations are sent from the PDAs 208-212 through the PCI server 214 and the internet 204 back to the plan manager 200, which will modify the investment vehicle allocations of the account accordingly.

The portfolio selection system 102 periodically recalculates a range of portfolios appearing on an efficient frontier at a pre-selected interval, and these new portfolio selections will be used by the plan manager 200 to repopulate the investment vehicle table 202.

A representative software architecture for carrying out the invention is illustrated in FIG. 12. As mentioned before, a database 140 of historical data on the performance of a variety of risky assets is provided as an input to a statistical resampling engine 142. As an output of the resampling engine 142, summary resampled asset data 144, typically including for each resampled asset an expected return, a standard deviation and correlations to other risky assets, are stored in a memory and are input to an efficient frontier calculator 146, which assembles an efficient frontier of portfolios from these resampled data. The efficient frontier calculator 146 will derive many such simulated efficient frontiers in the course of performing the process of the invention.

The results of the simulated efficient frontier calculator 146 are used by a simulated portfolio selector 148 to identify particular portfolios ranged along each efficient frontier, taken for example at predetermined intervals. These simulated portfolios are accumulated in a database or data set memory 150.

The operator of the system separately sets up and stores the desired standard deviation (or other portfolio performance measure) interval assumptions at step 152; preferably these intervals are plural, are contiguous and are of equal range, but they don't have to be. The assumptions recorded by module 152 are used as an input to an interval assignor 153, which assigns each of the simulated portfolios stored on database 150 to one interval, or possibly more than one interval if the ranges of the intervals have been predetermined to overlap. Next, the interval assignor 153 submits, for each interval, the portfolios assigned to the interval to a portfolio combiner 154, which employs summary statistics on these interval-assigned portfolios to derive, for each of the predetermined intervals, and a resampled portfolio 156. These portfolios and associated data may be presented to the investor or investment manager for review and selection. The representative architecture shown in FIG. 12 consists of defined modules of executable instructions, but other organizations of logic flow and data architecture could accomplish the same tasks, as is well understood by those skilled in the art.

FIG. 5 shows a graph with three different efficient frontiers based on one sample set of risky assets. The graph includes a mean variance frontier (dashes), a Michaud-type resampled efficient frontier (long and short dashes), and an efficient frontier using the method of the current invention (solid line, representing 200 resampled bins). It can be seen that all three frontiers are very similar in this example.

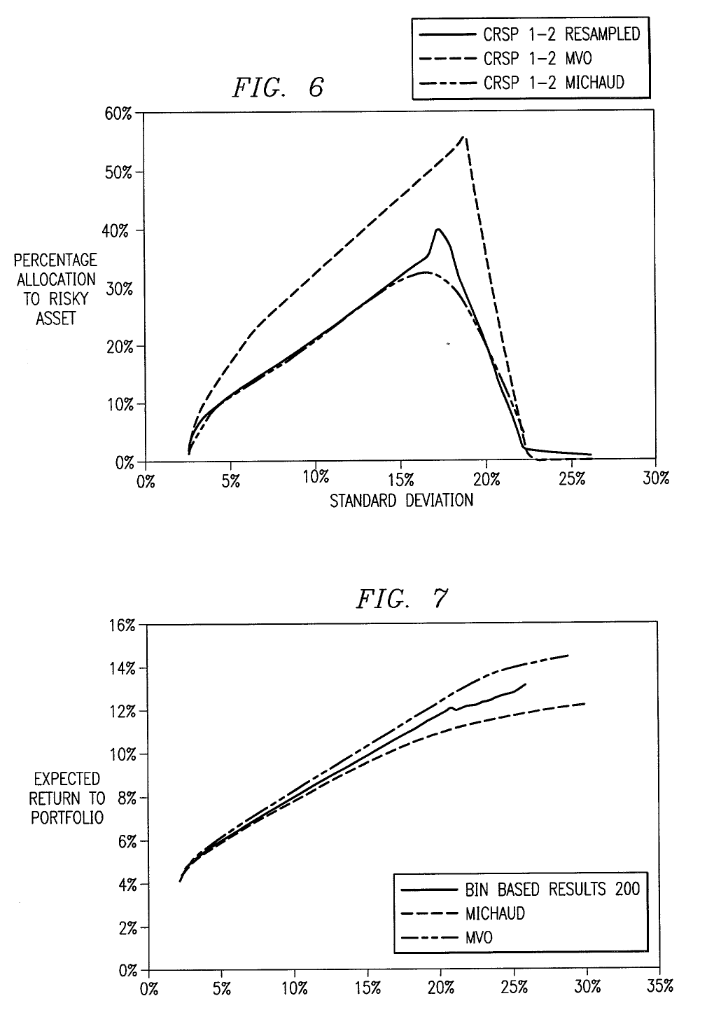

FIG. 6 shows a graph using the set of risky assets of FIG. 5 and displaying the percentage allocation to one risky asset in efficient frontier portfolios as a function of expected standard deviation of the portfolio. It can be seen that both resampling methods produce portfolios that are significantly different from the mean-variance optimized (MVO) portfolio in their allocation of this asset. It can also be seen that the current resampling method leads to allocations substantially different from the Michaud resampling method in a portion of the middle risk range.

FIG. 7 shows a graph based on another set of risky assets that includes U.S. Large Capitalization Value stocks and Latin American Equity. It can be seen that the efficient frontiers differ appreciably, depending on the method used. The resampled efficient frontier generated by the method of the current invention (bin based results 200) produces expected returns intermediate between those of the mean-variance frontier and the Michaud method.

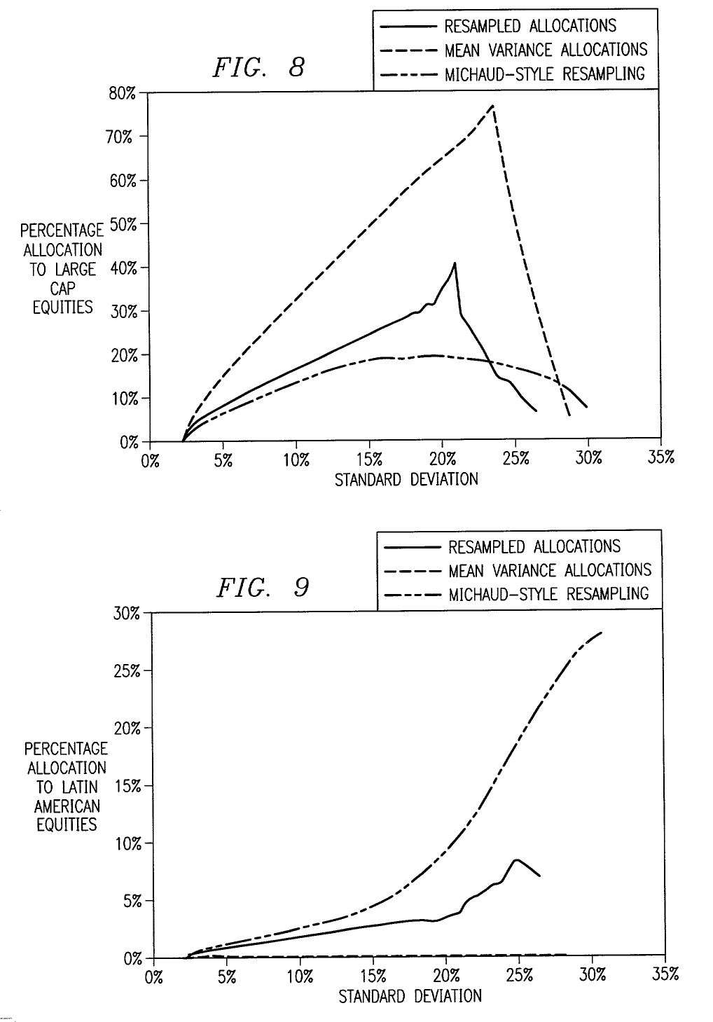

FIG. 8 shows a graph based on the same set of risky assets as FIG. 7 and displaying the percentage allocation to U.S. Large Capitalization Value equities in efficient frontier portfolios as a function of expected standard deviation of the portfolio for this new set of assets. It can be seen that the three methods produce very different allocations. Over a significant range of expected risk levels, the method of the current invention (reassigned) produces results intermediate between those of the Michaud method and the unresampled efficient frontier (mean variance allocations).

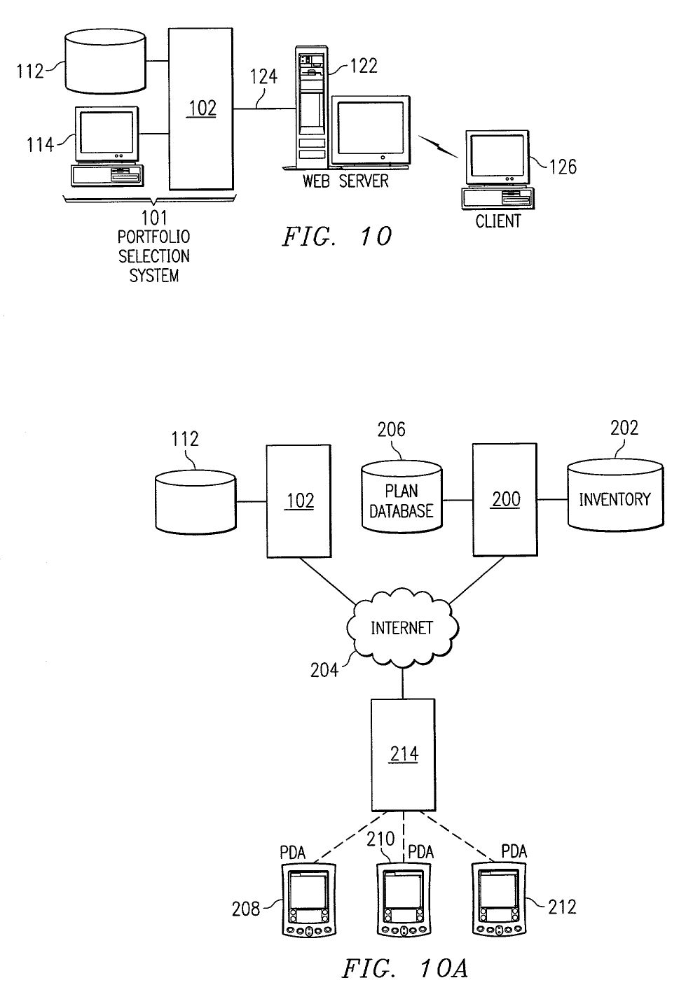

FIG. 9 shows a graph based on the same set of risky assets as FIG. 7 and displaying the percentage allocation to Latin American equities in efficient frontier portfolios as a function of expected standard deviation of the portfolio for this new set of assets. Unresampled mean variance optimization (dashes) leads to no allocations to this asset class at any risk level. The Michaud method leads to very large allocations at high risk levels. The method of the current invention (solid line) produces results similar to the Michaud method at low risk levels but allocations grow at a much slower rate with increasing risk.

These results demonstrate qualitatively different functionality due to the structural differences previously noted.

In summary, a method of investment portfolio selection has been shown and described which performs statistical resampling on a set of risky assets, which constructs a series of simulated efficient frontiers of portfolios of these assets, which divides the simulated efficient frontiers into predetermined intervals, and which performs summary statistical operations on the portfolios in each one of the intervals to derive a set of portfolios on a resampled efficient frontier.

While preferred embodiments of the present invention have been described in the above detailed description, and illustrated in the drawings, the invention is not limited thereto but only by the scope and spirit of the appended claims.

We claim:

1. A method for determining portfolios on a resampled efficient frontier for a set of risky assets, each risky asset having a return characterized by statistical input parameters, comprising:
a. selecting a portfolio performance measure,
b. defining a plurality of intervals each covering a range of the portfolio performance measure;
c. for each of a plurality of simulations, using a resampling procedure to revise at least one statistical input parameter of each risky asset in the set of risky assets to produce a simulated set of risky assets;
d. for each simulation, computing, from the simulated set of risky assets, at least one simulated portfolio on a simulated efficient frontier;
e. for each simulated portfolio in the plurality of simulated portfolios generated in step (d), assigning the simulated portfolio to at least one of a plurality of groups, each group being associated with a respective one of said intervals, the assignment based on whether a realized value of the portfolio performance measure of the simulated portfolio is in the range of the portfolio performance measure of the interval;
f. for each interval, using summary statistics derived from the simulated portfolios associated with the interval to generate a portfolio on a resampled efficient frontier; and
g. performing at least one of the following steps: (i) presenting the last said portfolios to an investor or investment manager as a guide to investment portfolio selection or (ii) submitting the last said portfolios as inputs to an automated account manager procedures or a multiperiod optimization procedure.

2. The method of claim 1 wherein values of the portfolio performance measure for a simulated portfolio are based on original unresampled statistical input parameters for returns of the risky assets.

3. The method of claim 1 wherein the statistical input parameters for each risky asset are an expected return, a standard deviation in return, and, for each possible pairing of the last said risky asset with each of the other risky assets, a correlation coefficient of expected returns.

4. The method of claim 1 wherein a plurality of portfolios on the resampled efficient frontier are generated.

5. The method of claim 1, and further comprising the step of generating an original efficient frontier based on the original statistical input parameters.

6. The method of claim 1 wherein the statistical input parameters are generated from a plurality of historically observed returns for each asset.

7. The method of claim 1 wherein the portfolio performance measure is a standard deviation of the return of a portfolio.

8. The method of claim 7 wherein the minimum value of the standard deviation of the simulated efficient frontier is the standard deviation of the minimum standard deviation portfolio on a mean-variance efficient frontier.

9. The method of claim 7 wherein the maximum value of standard deviation of the simulated efficient frontier is the standard deviation of the risky asset with the maximum expected return.

10. The method of claim 1 wherein the portfolio performance measure is an expected return.

11. The method of claim 5, and further comprising the steps of constructing portfolios which are linear combinations of portfolios on the resampled efficient frontier and portfolios on the original efficient frontier; and
extending the resampled efficient frontier with the constructed portfolios to cover the same range of portfolio measure as does the unresampled efficient frontier.

12. The method of claim 1 wherein each simulated efficient frontier is generated using a mean-variance optimization technique.

13. The method of claim 1 wherein the efficient frontier is generated using a mean-gini optimization technique.

14. The method of claim 1 wherein the efficient frontier is generated using a mean-stable distribution optimization technique.

15. The method of claim 1 wherein at least one gap-filling, additional portfolio on the resampled efficient frontier is generated by creating a weighted linear combination of a plurality of existing portfolios on the resampled efficient frontier.

16. The method of claim 1 wherein the intervals of the portfolio performance measure are of equal size.

17. The method of claim 1 wherein the union of the intervals of the portfolio performance comprises the entire selected range of the portfolio performance measure.

18. The method of claim 1 wherein the intervals of the portfolio performance measure are non-overlapping.

19. The method of claim 1 wherein the intervals of the portfolio performance measure are overlapping.

20. The method of claim 1 wherein the portfolio weights for a risky asset over the range of the portfolio performance measure are adjusted using a smoothing procedure such as Chebyshev polynomial regression, Fourier transform, wavelets, exponential smoothing, or a spline method.

21. A method for generating portfolios for possible investment from a plurality of risky assets, comprising the steps of:
providing a set of risky assets each having a plurality of historical returns which have been characterized by at least two statistical input parameters;
selecting a portfolio performance measure having a first range of values;
defining a plurality of intervals each having a second range of values which is a subset of the first range of values;
for each of a plurality of simulations, using a resampling procedure to revise at least one of the statistical input parameters so as to generate a resampled set of risky assets;
for each of the plurality of simulations, generating a simulated efficient frontier composed of portfolios of resampled risky assets;
for each of the last said portfolios, assigning the portfolio to at least one of the intervals based on the value of the statistical input parameters thereof;
for each interval, using summary statistics derived from all portfolios associated with the interval to generate a portfolio for that interval on a resampled efficient frontier; and
presenting results to an investor or investment manager as a guide to investment portfolio selection or using results of the resampling process as an input to another computational process such as automated account management procedure or a multiperiod optimization procedure.

22. The method of claim 21, and further comprising the step of dividing the first range of portfolio performance measure values to derive the intervals characterized by a set of second ranges such that these ranges are non-overlapping and entirely cover the first range.

23. The method of claim 22, wherein the second ranges are of equal magnitude.

24. The method of claim 21, wherein the portfolio performance measure is a standard deviation and two of the statistical input parameters of the risky assets are standard deviation and expected return, the first range extending from the standard deviation of the portfolio with the lowest standard deviation to the standard deviation of the risky asset having the highest expected return.

25. The method of claim 21, wherein the portfolio performance measure is selected from the group consisting of expected return and standard deviation.

26. The method of claim 21, wherein the ranges of the intervals of the portfolio performance measure overlap.

27. The method of claim 21, wherein the portfolios generated using summary statistics are mean portfolios.

28. The method of claim 21, and further comprising the step of
prior to said step of generating the resampled efficient frontiers, smoothing the resampled data set by applying a smoothing procedure to the resampled data.

29. The method of claim 21, and further comprising the step of
generating at least one gap-filling portfolio to reside on the resampled efficient frontier by linear combinations of adjacent ones of said portfolios generated using summary statistics.

30. The method of claim 21, and further comprising the step of
extending the resampled efficient frontier by making at least one linear combination of one of said portfolios generated using summary statistics and a portfolio assembled using unresampled statistical input parameters.

31. A method for creating a plurality of investment portfolios on an efficient frontier, the portfolios varying from each other in risk and return, the method comprising the steps of:
selecting a plurality of risky assets for possible inclusion in one or more of the portfolios;
generating resampled data on each of the risky assets, the data for each risky asset including an expected return, a measure of risk, and a measure of correlation to each other risky asset;
from the resampled data, creating a simulated efficient frontier of simulated portfolios;
repeating said steps of generating and creating for a plurality of simulations to generate a plurality of simulated efficient frontiers;
establishing a plurality of intervals of a performance measure where each of the simulated portfolios can have attributed to it a value of the performance measure;
assigning each of the simulated portfolios to at least one of the intervals based on the value of the performance measure of the simulated portfolio;
for each interval, combining the characteristics of each simulated portfolio assigned to that interval to create a proposed investment portfolio for that interval; and
presenting results to an investor or investment manager as a guide to investment portfolio selection or using results of the resampling process an input to another computational process such as automated account management procedure or a multiperiod optimization procedure.

32. The method of claim 31, wherein the step of establishing the intervals of the performance measure includes dividing the entire range of the performance measure for a portfolio of unresampled risky assets having the minimum value of the performance measure to the risky asset having a maximum value of the performance measure.

33. The method of claim 32, wherein the intervals have ranges of equal magnitude.

34. The method of claim 31, wherein the portfolio performance measure is selected from the group consisting of expected return and standard deviation.

35. The method of claim 31, wherein the ranges of the intervals overlap.

36. The method of claim 31, wherein, for each interval, the proposed investment portfolio is a mean portfolio.

37. A machine-readable medium having stored thereon data representing sequences of instructions, the sequences of instructions which, when executed by a processor, cause the processor to perform the steps of:
defining a plurality of intervals within a first range of a portfolio performance measure, each of the intervals having a second range which is a subset of the first range;
for a set of risky assets and for each of a plurality of simulations using a resampling procedure to revise at least one statistical input parameter of each risky asset to generate a resampled set of risky assets;
for each of the plurality of simulations, generating an efficient frontier composed of simulated portfolios of resampled risky assets;
for each simulated portfolio, assigning the simulated portfolio to at least one of the intervals based on the value of the statistical input parameters thereof;
for each interval, using summary statistics derived from all simulated portfolios associated with the interval to generate a recommended portfolio for that interval on a resampled efficient frontier; and
presenting results to an investor or investment manager as a guide to investment portfolio selection or using results of the resampling process as an input to another computational process such as automated account management procedure or a multiperiod optimization procedure.

38. The medium of claim 37, wherein the processor is programmed by machine-readable instructions read from the medium to perform the further step of
dividing the first range of the portfolio performance measure to obtain the second ranges.

39. The medium of claim 38, wherein the second ranges are all of equal magnitude.

40. The medium of claim 37, wherein the processor is programmed by machine-readable instructions read from the medium to perform the further steps of
establishing a minimum of the portfolio performance measure by finding the minimum value of that portfolio performance measure as a statistical input parameter of the risky assets; and
establishing a maximum of the portfolio performance measure as equal to the value of the portfolio performance measure possessed by the risky asset exhibiting the highest value of a statistical input parameter other than the portfolio performance measure.

41. The medium of claim 37, wherein the portfolio performance measure is preselected from the group consisting of expected return and standard deviation.

42. The medium of claim 37, wherein the ranges of the intervals overlap.

43. The medium of claim 37, wherein the summary statistics are used to generate mean portfolios on the resampled efficient frontier.

44. A computer system comprising:
a storage device having stored therein a portfolio optimization routine for generating a plurality of portfolios for selection by an investor, and a database of risky assets each characterized by at least two statistical input parameters measuring characteristics of the returns of the risky assets;
a processor coupled to the storage device for executing the portfolio optimization routine, wherein the processor defines a plurality of intervals each having a second range of values which is a subset of a first range of values of a portfolio performance measure, the processor using, for each of a plurality of simulations, a resampling procedure of the portfolio optimization routine to revise at least one of the statistical input parameters to generate, for each simulation, a resampled set of risky assets, the processor, for each simulation, generating an efficient frontier composed of portfolios of resampled risky assets, the processor assigning each of the last said portfolios to one or more of the intervals based on a value for the portfolio of the portfolio performance measure, the processor using a summary statistical procedure of the optimization routine to derive, for each interval and from the portfolios assigned to the interval, a portfolio on a resampled efficient frontier; and
a display coupled to the processor for displaying to an investor or investment manager at least some of the portfolios on the resampled efficient frontier.

45. The system of claim 44, wherein the processor divides the first range of the portfolio performance measure to obtain the second ranges.

46. The system of claim 45, wherein the second ranges are of equal magnitude.

47. The system of claim 44, wherein the portfolio performance measure is preselected from the group consisting of expected return and standard deviation in return.

48. The system of claim 44, wherein the second ranges of the intervals overlap.

49. The system of claim 44, wherein the minimum of the first range of the portfolio performance measure is established by the minimum value of that measure attributed to any of the risky assets, and the maximum of the first range of the portfolio performance measure is the value of the portfolio performance measure attributed to that risky asset having a maximum value of a predetermined other statistical parameter.

50. The system of claim 26, wherein the summary statistical procedure derives mean portfolios on the resampled efficient frontier.

51. A data signal embodied in a propagation medium, the data signal including a plurality of instructions, which when executed by a processor, cause the processor to perform the steps of:
defining a plurality of intervals within a first range of a portfolio performance measure, each of the intervals having a second range which is a subset of the first range;
for a set of risky assets and for each of a plurality of simulations using a resampling procedure to revise at least one statistical input parameter of each risky asset to generate a resampled set of risky assets;
for each of the plurality of simulations, generating an efficient frontier composed of portfolios of resampled risky assets;
for each of the last said portfolios, assigning the portfolio to at least one of the intervals based on the value of the statistical input parameters thereof;
for each interval, using summary statistics derived from all portfolios associated with the interval to generate a portfolio for that interval on a resampled efficient frontier; and
performing one of the following steps:
presenting results to an investor or investment manager as a guide to investment portfolio selection or using results of the resampling process as an input to another computational process such as automated account management procedure or a multiperiod optimization procedure.

52. The signal of claim 51, wherein the second ranges of the intervals overlap.

53. The signal of claim 51, wherein the portfolio performance measure is preselected from the group consisting of expected return and standard deviation of return.

54. The signal of claim 51, wherein the summary statistics are used to generate a plurality of mean portfolios on the resampled efficient frontier.

55. A system for creating a plurality of investment portfolios for presentation to an investor or investment advisor or for use an input to another computational process such as automated account management procedure or a multiperiod optimization procedure, comprising:
a storage device for storing a database of risky assets, each risky asset characterized by at least two statistical input parameters measuring performance of the asset;
a resampling engine coupled to the storage device for performing, for each of a plurality of simulations, a resampling procedure on the risky assets, such that, for each risky asset, a value of at least one of the statistical input parameters is replaced, the resampling engine producing, for each of the simulations, a resampled set of risky assets;
an efficient frontier calculator coupled to the resampling engine and operating on each resampled set of risky assets to produce a plurality of simulated investment portfolios on an efficient frontier, the simulated investment portfolios stored in a first memory;
a second memory for storing interval definitions for a plurality of intervals, each interval defined by a second range of values of a statistical input parameter, the second ranges being subsets of a first range of said values;
an interval assignor coupled to the second memory and the first memory for assigning each of the simulated investment portfolios to at least one of the intervals, based on a value a statistical input parameter of the simulated investment portfolio and the range of values of the statistical input parameter attributed to the interval;
a portfolio combiner coupled to the interval assignor, the portfolio combiner performing, for each of a selected number of the intervals, a summary statistical procedure to derive a recommended investment portfolio associated with that interval, the recommended investment portfolio residing on a resampled efficient frontier; and
an output coupled to the portfolio combiner for outputting characteristics of each of the recommended investment portfolios.

56. The system of claim 55, wherein each simulated investment portfolio is assigned to a single interval.

57. The system of claim 55, wherein the statistical input parameter used to define the intervals is selected from the group consisting of expected return and standard deviation in return.

58. The system of claim 55 wherein the intervals are nonoverlapping.

59. The system of claim 58, wherein the second ranges are obtained by dividing the first range of the portfolio performance measure.

60. The system of claim 55, wherein the intervals overlap.

61. The system of claim 55, wherein the intervals are equal in magnitude.

62. The system of claim 55, wherein the minimum of the first range is equated to the minimum value of that portfolio performance measure attributed to any of the risky assets, and the maximum of the first range is equated to the portfolio performance measure value attributed to that asset having a maximum value of another, predetermined statistical input parameter.

63. The system of claim 55, wherein the statistical input parameters stored in the risky asset database include mean return, standard deviation in return, and a correlation to each other risky asset.

64. The system of claim 55, wherein the portfolio combiner generates, for each interval, a mean portfolio on the resampled efficient frontier.

65. The system of claim 55, and further including a display coupled to the output for displaying the recommended investment portfolios to an investor or investment manager as a guide to investment portfolio selection.

66. The system of claim 55, and further including an automated account manager coupled to the output of the portfolio combiner for receiving data characterizing the recommended investment portfolios, the automated account manager managing at least one investment account as a function of the received data.

67. The system of claim 55, and further including a multiperiod optimization engine coupled to the output of the portfolio combiner for receiving data characterizing the recommended investment portfolios.
